(19) United States
(12) Patent Application Publication
(10) Pub. No.: US 2025/0169624 A1
(43) Pub. Date: May 29, 2025

(54) CONTROLLABLE FRONT DOOR OPENING STRUCTURE FOR DOUBLE-DOOR DISPLAY CASE

(71) Applicant: Ningbo Rotor Electrical Appliances Co., Ltd., Ningbo (CN)

(72) Inventor: Jiguang YAN, Ningbo (CN)

(73) Assignee: Ningbo Rotor Electrical Appliances Co., Ltd., Ningbo (CN)

(21) Appl. No.: 18/628,821

(22) Filed: Apr. 8, 2024

(30) Foreign Application Priority Data
Nov. 25, 2023 (CN) 202323201346.1

(51) Int. Cl. A47F 3/00; E05B 65/00; E05C 19/00

(52) U.S. Cl. CPC A47F 3/007; E05B 65/00; E05C 19/007; A47F 2003/008

(57) ABSTRACT

A controllable front door opening structure for a double-door display case includes a case body, where a front side of the case body is rotatably connected to a front door; an inner side of the front door is connected to a limiting member; the limiting member rotates synchronously with the front door; a locking member is provided in the case body; the locking member limits rotation of the limiting member; and the locking member translates or rotates to unlock the limiting member. By controlling the locking member at a rear door of the case body to move forward and backward or to rotate, the front door is locked or unlocked.

### CROSS-REFERENCE TO THE RELATED APPLICATIONS

This application is based upon and claims priority to Chinese Patent Application No. 202323201346.1, filed on Nov. 25, 2023, the entire contents of which are incorporated herein by reference.

### TECHNICAL FIELD

The present disclosure relates to the technical field of display cases (cold, hot, and normal-temperature), and in particular to a controllable front door opening structure for a double-door display case.

### BACKGROUND

With the acceleration of people's life rhythm, and the continuous transformation and upgrading of food consumption, fast foods and freshly prepared foods are popular in markets. In large supermarkets, convenience stores, etc., a double-door display case with an openable front door and an openable rear door is increasingly in demanded.

According to the prior art, the front door and the rear door of the double-door display case can be opened at the same time in use. The rear door is available for sellers to place commodities, while the front door is available for customers to take the commodities for use. Such a display case is very popular in markets. However, in response to different shopping places, storage of different commodities, or placement of a same commodity at different sales periods, the front door is not allowed to be opened freely. For example, when hot foods are just placed in an insulated display case, the front door is not allowed to be opened freely, for fear of scalds to the customers. Sometimes, there is no controllable opening function for the front door of the double-door display case. Alternatively, the front door of the double-door display case is provided with a lock. When it is not desirable for the front door of the double-door display case to be opened by the customers, the front door of the double-door display case is locked. This is not aesthetically pleasing, and does not facilitate on-site operation.

### SUMMARY

An objective of the present disclosure is to provide a controllable front door opening structure for a double-door display case, to solve the problem that opening or closing of a front door of an existing display case cannot be controlled from a rear door in the background.

To solve the technical problems, the present disclosure adopts the following technical solutions.

A controllable front door opening structure for a double-door display case includes a case body, where a front side of the case body is rotatably connected to a front door; an inner side of the front door is connected to a limiting member; the limiting member rotates synchronously with the front door; a locking member is provided in the case body; the locking member limits rotation of the limiting member; and the locking member translates or rotates to unlock the limiting member.

Preferably, the limiting member includes a backward-extending first limiting portion; the locking member includes a first locking portion or a second locking portion; the first locking portion or the second locking portion extends to a rotating path of the first limiting portion; and the first locking portion translates or the second locking portion rotates to separate from the rotating path of the first limiting portion.

Preferably, the limiting member includes a second limiting portion spaced apart from the front door; the locking member includes a second locking portion; and the locking member rotates, such that the second locking portion extends to a front side of the second limiting portion; or the locking member rotates, such that the second locking portion moves out of a space between the second limiting portion and the front door.

Preferably, the front door is rotatably connected to the case body through a horizontally-extending rotating shaft; a rack is provided in the case body; and the locking member is provided on a bottom or an upper portion of the rack, and/or provided on an inner top of the case body or an inner bottom of the case body.

Preferably, the locking member is slidable forward and backward on the bottom of the rack, and/or the locking member is slidably provided on the inner top of the case body; the limiting member is located between the locking member and the rack, and/or the limiting member is located between the locking member and the inner top of the case body; and the locking member moves backward to separate from a rotating path of the limiting member.

Preferably, a left sidewall and a right sidewall of the case body each are provided with a guiding track; the rack drives the locking member to move forward and backward along the guiding track; the rack moves backward; and the locking member moves backward to separate from a rotating path of the limiting member.

Preferably, a locating member is provided on the bottom of the rack or the inner top of the case body; a locating hole is formed in the locating member; the locking member further includes a connecting rod extending forward and backward; a front portion of the connecting rod is connected to the second locking portion; the connecting rod penetrates through the locating hole; and the connecting rod rotates to drive the second locking portion to rotate.

Preferably, the rotating shaft is provided on the case body; an upper end of the front door is provided with a shaft sleeve; the shaft sleeve is sleeved on an outer side of the rotating shaft, and is capable of rotating around the rotating shaft; and the limiting member is fixedly connected to the shaft sleeve.

Preferably, a locating assembly is further provided between the rack and the locking member, or between the inner top of the case body and the locking member; the locating assembly includes a guiding groove and a guiding member; and one of the guiding groove and the guiding member is provided on the rack or the inner top of the case body, and the other of the guiding groove and the guiding member is provided on the locking member.

Preferably, a rear end of the locking member is provided with a grip.

The present disclosure has the following advantages over the prior art:

1. When the rear door is opened, relative positions of the locking member and the limiting member are changed by moving the locking member forward and backward, thereby controlling opening or closing of the front door. When the locking member moves forward, the locking member on the bottom of the rack is located under the limiting member of the front door, and on the rotating path of the limiting member, such that the limiting member gets stuck and cannot rotate, and the front door cannot rotate to open. When the locking member moves backward, the locking member is not located on a path through which the limiting member must pass in rotation. That is, the locking member cannot prevent rotation of the limiting member. The front door can rotate through the shaft sleeve, and the front door can be opened freely.

2. Through the rotatable locking member, the first locking portion or the second locking portion rotates to the rotating path of the limiting member for locking. Therefore, the limiting member cannot rotate, and the front door cannot rotate to open. When the first locking portion or the second locking portion rotates away from the rotating path, the limiting member can rotate to open.

### BRIEF DESCRIPTION OF THE DRAWINGS

To describe the technical solutions in the specific implementations of the present disclosure or the prior art more clearly, the accompanying drawings required for describing the specific implementations or the prior art are briefly described below. Apparently, the accompanying drawings in the following description show merely some implementations of the present disclosure, and those of ordinary skill in the art may still derive other accompanying drawings from these accompanying drawings without creative efforts.

FIG. 1 is a first schematic structural view of a controllable front door opening structure for a double-door display case according to Embodiment 1;

FIG. 2 is an enlarged view of A shown in FIG. 1;

FIG. 3 is a second schematic structural view of a controllable front door opening structure for a double-door display case according to Embodiment 1;

FIG. 4 is a schematic structural view of a locking member according to Embodiment 1;

FIG. 5 is a schematic structural view of a front door according to Embodiment 1;

FIG. 6 is a first schematic structural view of a controllable front door opening structure for a double-door display case according to Embodiment 3;

FIG. 7 is an enlarged view of B shown in FIG. 6;

FIG. 8 is a schematic structural view of a locating member according to Embodiment 3;

FIG. 9 is a schematic structural view of a locking member according to Embodiment 3;

FIG. 10 is a schematic structural view of a controllable front door opening structure for a double-door display case according to Embodiment 4;

FIG. 11 is a first schematic structural view of a controllable front door opening structure for a double-door display case according to Embodiment 5;

FIG. 12 is an enlarged view of C shown in FIG. 11;

FIG. 13 is a second schematic structural view of a controllable front door opening structure for a double-door display case according to Embodiment 5;

FIG. 14 is an enlarged view of D shown in FIG. 13;

FIG. 15 is a first schematic structural view of a controllable front door opening structure for a double-door display case according to Embodiment 6; and

FIG. 16 is an enlarged view of E shown in FIG. 15.

In the figures: 1: case body, 11: front door, 12: rear door, 2: limiting member, 21: first limiting portion, 211: lockhole, 22: second limiting portion, 3: locking member, 31: first locking portion, 32: second locking portion, 33: guiding groove, 34: grip, 35: connecting rod, 36: lock piece, 361: guiding surface, 362: lock hook, 363: locating post, 364: avoidance groove, 37: pivot shaft, 38: driving portion, 39: compression spring, 4: rack, 5: locating member, 51: locating hole, 6: shaft sleeve, 7: guiding member, and 8: accommodation space.

### DETAILED DESCRIPTION OF THE EMBODIMENTS

The following clearly and completely describes the technical solutions of the present disclosure with reference to accompanying drawings. Apparently, the described embodiments are merely some rather than all of the embodiments of the present disclosure.

### Embodiment 1

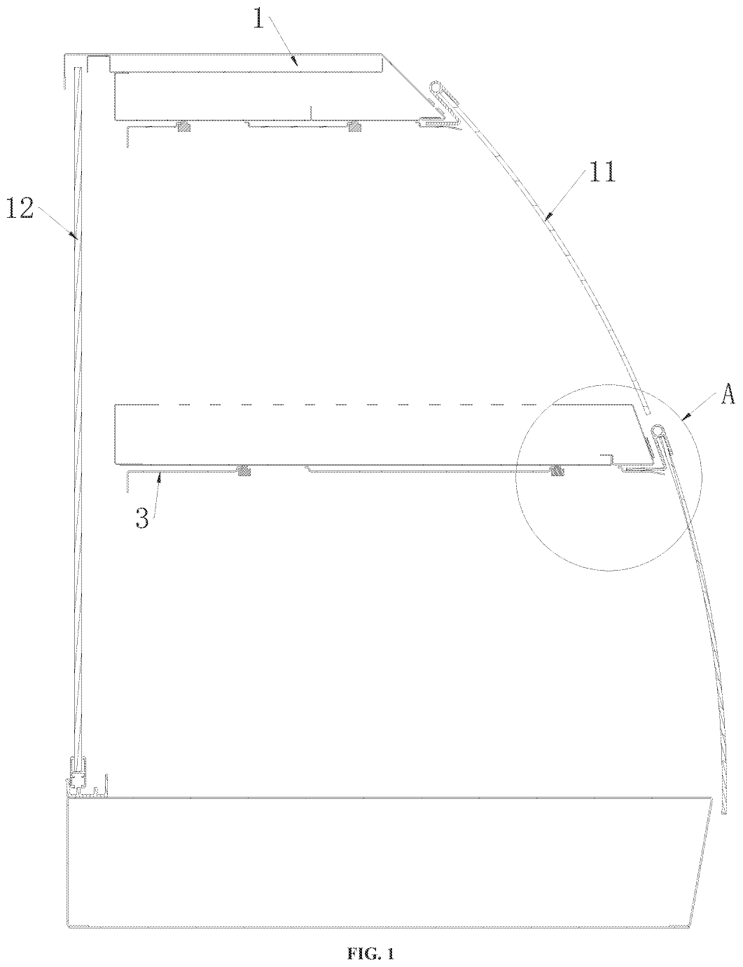

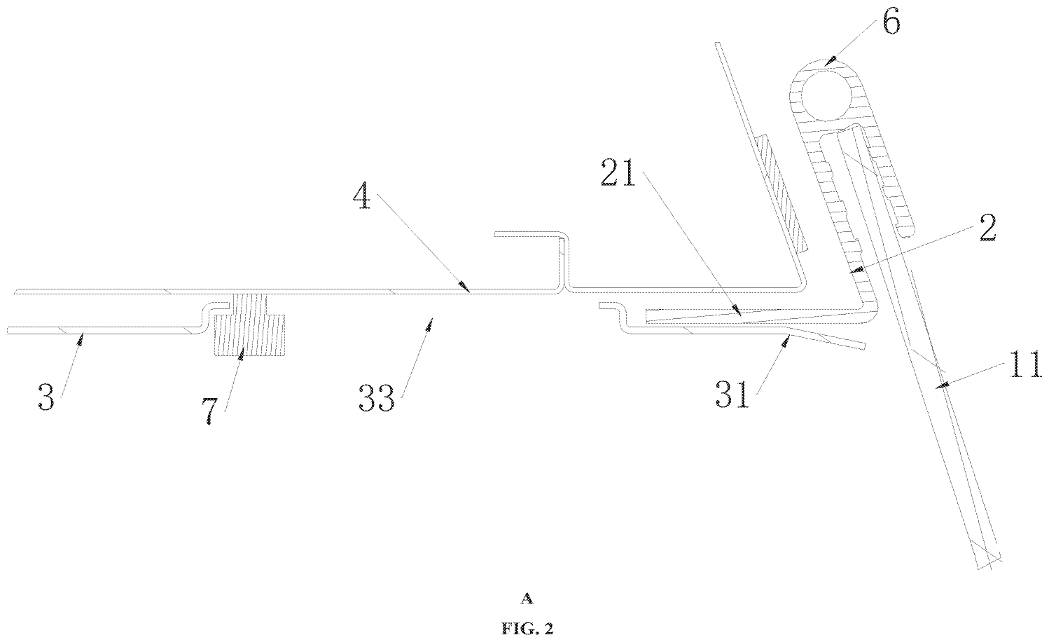

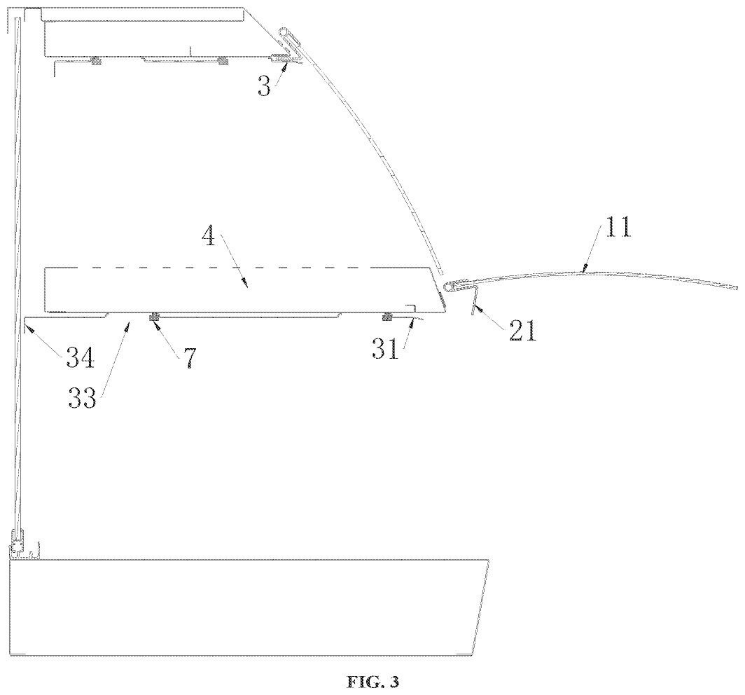

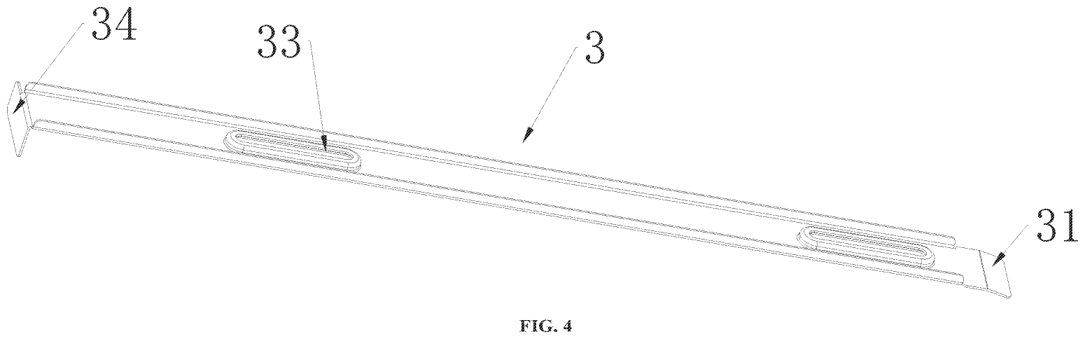

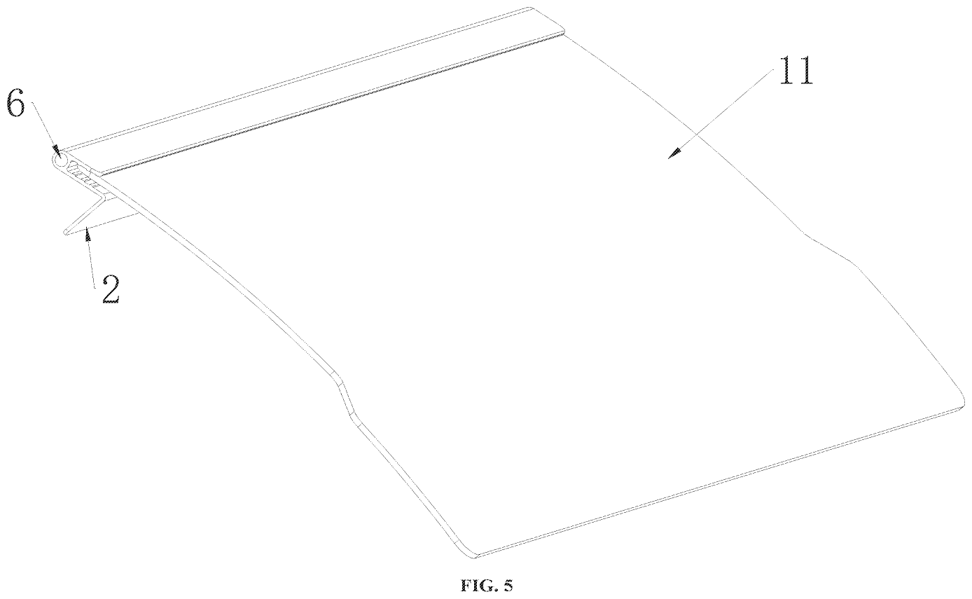

Referring to FIGS. 1-5, a controllable front door opening structure for a double-door display case includes case body 1. A front side of the case body 1 is rotatably connected to front door 11. An inner side of the front door 11 is connected to limiting member 2. The limiting member 2 rotates synchronously with the front door 11. Locking member 3 is provided in the case body 1. The locking member 3 limits rotation of the limiting member 2. The locking member 3 translates to unlock the limiting member 2. A rear side of the case body 1 is provided with rear door 12. A rear end of the locking member 3 is provided with grip 34, extends to a rear portion of the case body 1, and is close to the rear door 12 of the case body 1.

The limiting member 2 includes backward-extending first limiting portion 21. The locking member 3 includes first locking portion 31. The first locking portion 31 extends to a rotating path of the first limiting portion 21. The first locking portion 31 translates or rotates to separate from the rotating path of the first limiting portion 21.

In the embodiment, the case body 1 is rotatably connected to an upper end of the front door 11 through a horizontally-extending rotating shaft. Rack 4 is provided in a middle of the case body 1. There are two locking members 3 that are respectively slidable forward and backward on a bottom of the rack 4 and an inner top of the case body 1. One limiting member 2 is located between the locking member 3 and the rack 4, and the other limiting member 2 is located between the locking member 3 and an upper top of the case body 1. The locking member 3 moves backward to separate from a rotating path of the limiting member 2.

It is to be understood by those skilled in the art that when the front door 11 is flipped down to open, the limiting member 2 may be provided on an inner bottom of the case body 1, and may also be provided on an upper portion of the rack 4.

In the embodiment, the rotating shaft is provided on the case body 1. The upper end of the front door 11 is provided with shaft sleeve 6. The shaft sleeve 6 is sleeved on an outer side of the rotating shaft, and is capable of rotating around the rotating shaft. The limiting member 2 is fixedly connected to the shaft sleeve 6. It is to be understood by those skilled in the art that as long as the limiting member 2 is located on the inner side of the front door 11 and rotates with the front door 11 synchronously, and the locking member 3 is located on the rotating path of the limiting member 2, a locking effect can be achieved

Specifically, guiding groove 33 is formed in the locking member 3. A bolt as guiding member 7 is provided on a lower surface of the rack 4. A threaded rod of the bolt is fixed with the rack 4 after extending into the guiding groove from bottom to top. A cap of the bolt abuts against a lower surface of the locking member 3. The locking member 3 is located on the lower surface of the rack 4. Likewise, the threaded rod of the bolt is fixed with the inner top of the case body 1 after extending into the guiding groove from bottom to top. The cap of the bolt abuts against the lower surface of the locking member 3. The locking member 3 is located on the inner top of the case body 1. A distance moved by the locking member 3 forward and backward is limited by a length of the guiding groove 33.

The limiting member 2 and the locking member 3 each have various structures. Both may be a platy structure, and may also be a rod-like structure.

It is to be understood by those skilled in the art that the rotating shaft may be provided on the case body 1, and may also be provided on the front door 11, as long as the front door 11 is rotatably connected to the case body 1. The rotating shaft may also be provided on a middle-upper portion of the front door 11, or even on a middle-lower portion of the front door 11, or the rotating shaft is provided at a side of the front door 11. In all cases, the front door 11 can be flipped to open, and the controllable front door opening structure for a double-door display case in the present disclosure can be used. When the rotating shaft is provided on the middle-upper portion or the middle-lower portion of the front door 11, a portion of the front door 11 flipped to the case body 1 does not affect opening of the case door. When the rotating shaft is provided at a left side or a right side of the front door 11, the locking member 3 can still be provided on the bottom or the upper portion of the rack 4, and can also be provided at a left side or a right side in the case body 1.

In the embodiment, in response to the open rear door 12, when the locking member 3 moves forward, the locking member 3 on the bottom of the rack 4 or the inner top of the case body 1 is located under the limiting member 2 of the front door 11, and on the rotating path of the limiting member 2, such that the limiting member 2 gets stuck and cannot rotate, and the front door 11 cannot be opened. When the locking member 3 moves backward, the locking member 3 is separated from a path through which the limiting member 2 must pass in rotation. That is, the locking member 3 cannot prevent rotation of the limiting member 2. The front door 11 can rotate freely to open.

### Embodiment 2

The embodiment provides a controllable front door opening structure for a double-door display case. Different from Embodiment 1, a left sidewall and a right sidewall of the case body 1 in the embodiment each are provided with a guiding track. The locking member 3 is fixedly provided on the bottom of the rack 4 or a front end of the rack 4 serves as the locking member 3. The rack 4 drives the locking member 3 to move forward and backward along the guiding track. The limiting member 2 is located between the locking member 3 and the rack 4, or the limiting member 2 is located on the rack 4. The rack 4 moves backward. That is, the locking member 3 moves backward to separate from a rotating path of the limiting member 2.

### Embodiment 3

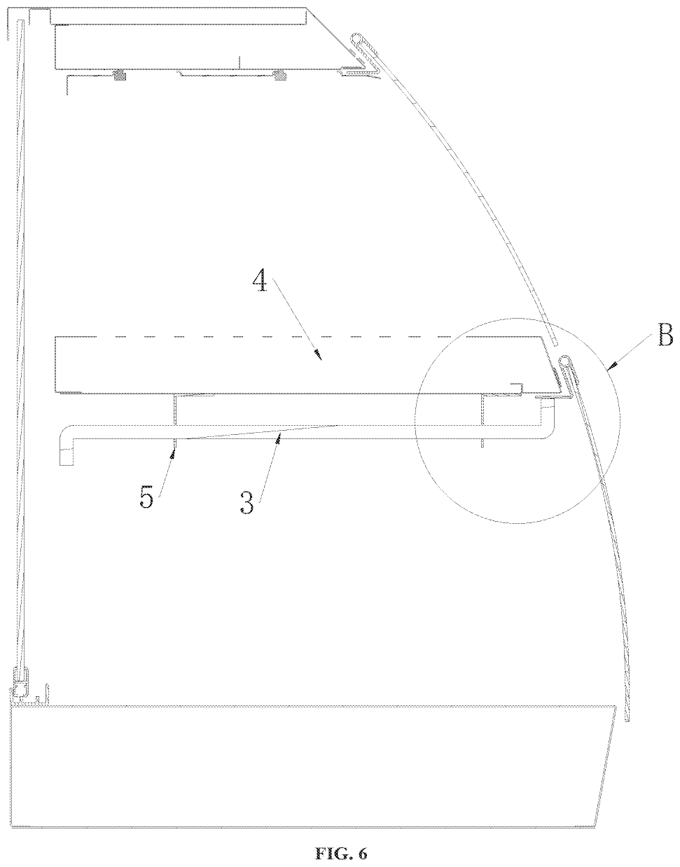

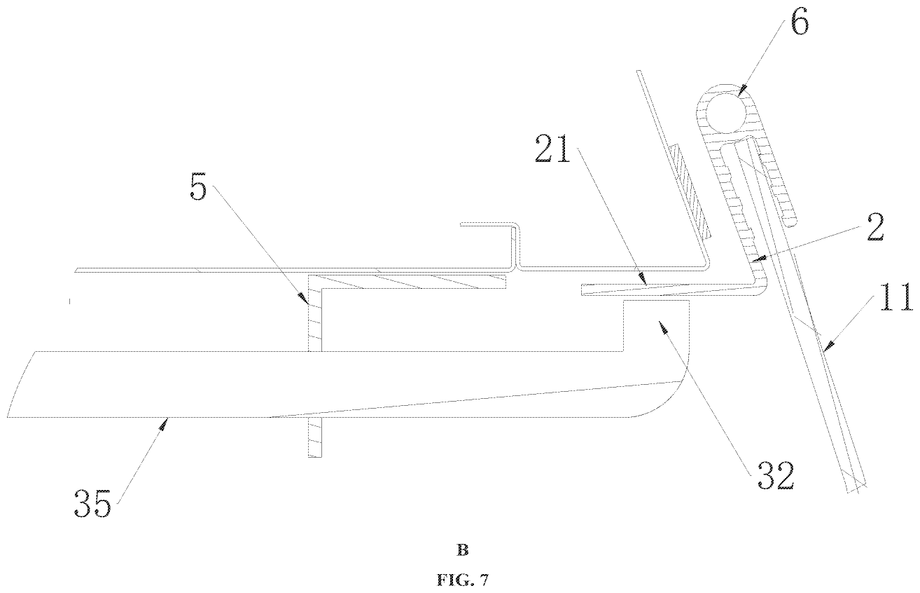

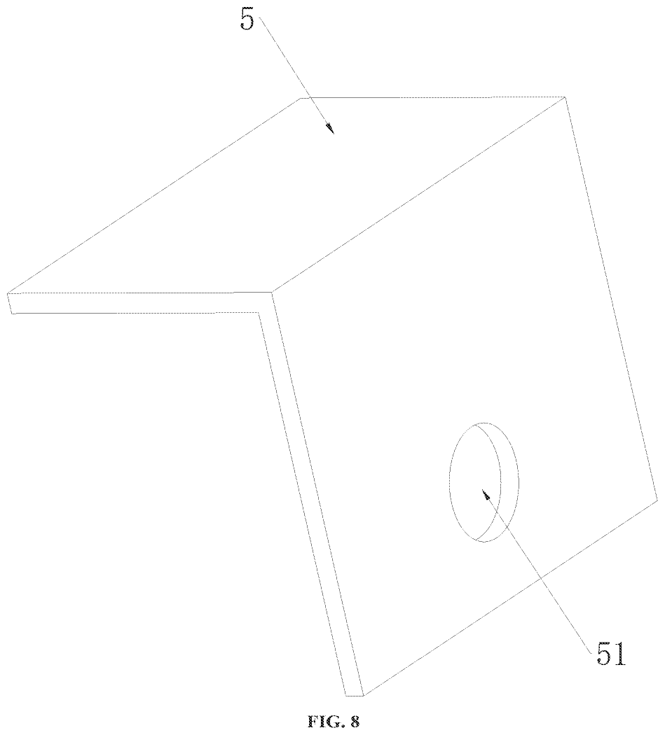

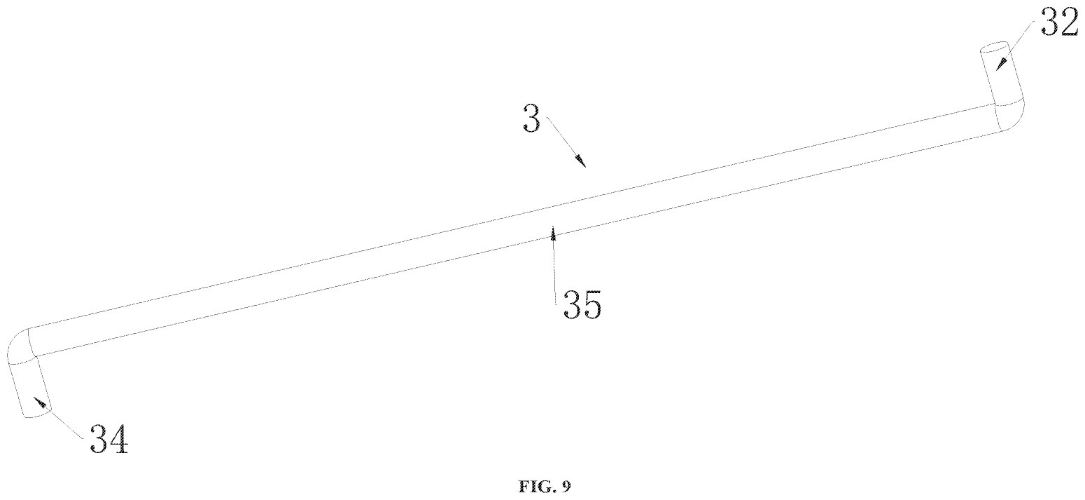

The embodiment provides a controllable front door opening structure for a double-door display case. Referring to FIGS. 6-9, different from Embodiment 1, the locking member 3 in the embodiment rotates to unlock the limiting member 2.

Locating member 5 is provided on the bottom of the rack 4 or the inner top of the case body 1. Locating hole 51 is formed in the locating member 5. The locking member 3 further includes connecting rod 35 extending forward and backward. A front portion of the connecting rod 35 is connected to the second locking portion 32. The connecting rod 35 penetrates through the locating hole 51. The connecting rod 35 rotates to drive the second locking portion 32 to rotate. A rear end of the connecting rod 35 is provided with grip 34. The grip 34, the connecting rod 35, and the second locking portion 32 are formed integrally. The grip 34 and the second locking portion 32 are respectively located at two ends of the connecting rod 35, and are perpendicular to the connecting rod 35. The grip 34 and the second locking portion 32 extend oppositely.

It is to be understood by those skilled in the art that the grip 34, the connecting rod 35, and the second locking portion 32 may also not be formed integrally, as long as rotating the grip 34 can drive the second locking portion 32 to rotate. Moreover, in some implementations, the use can also be convenient without the grip 34.

### Embodiment 4

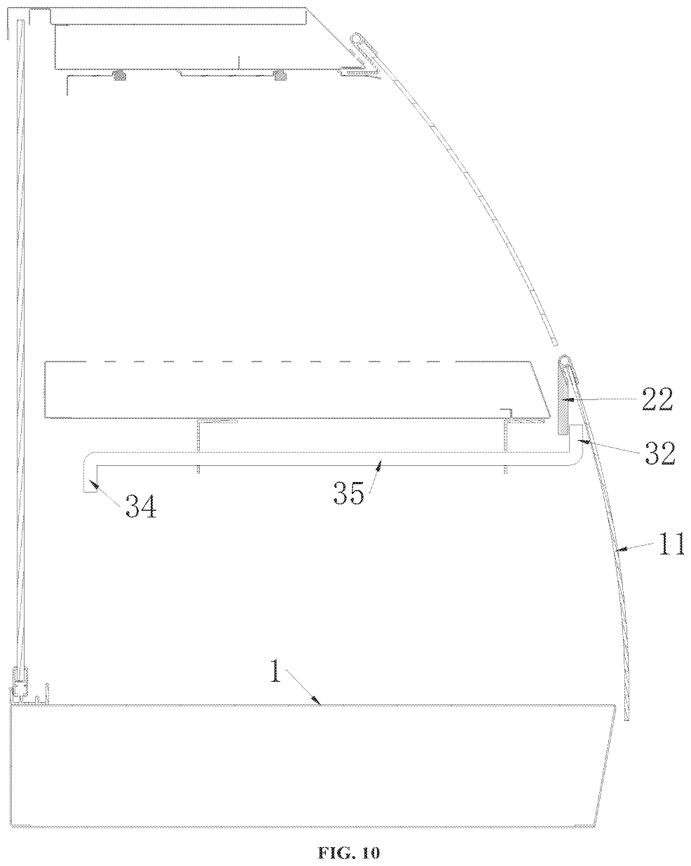

The embodiment provides a controllable front door opening structure for a double-door display case. Referring to FIG. 10, different from Embodiment 3, the limiting member 2 in the embodiment includes second limiting portion 22 spaced apart from the front door 11. The locking member 3 includes second locking portion 32. The locking member 3 rotates, such that the second locking portion 32 extends to a front side of the second limiting portion 22. Or the locking member 3 rotates, such that the second locking portion 32 moves out of a space between the second limiting portion 22 and the front door 11.

### Embodiment 5

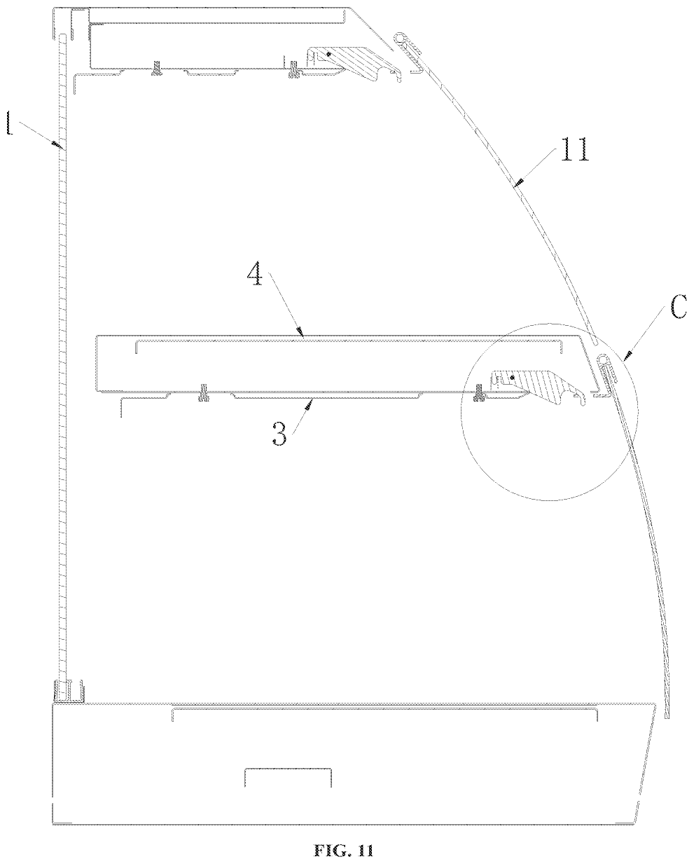

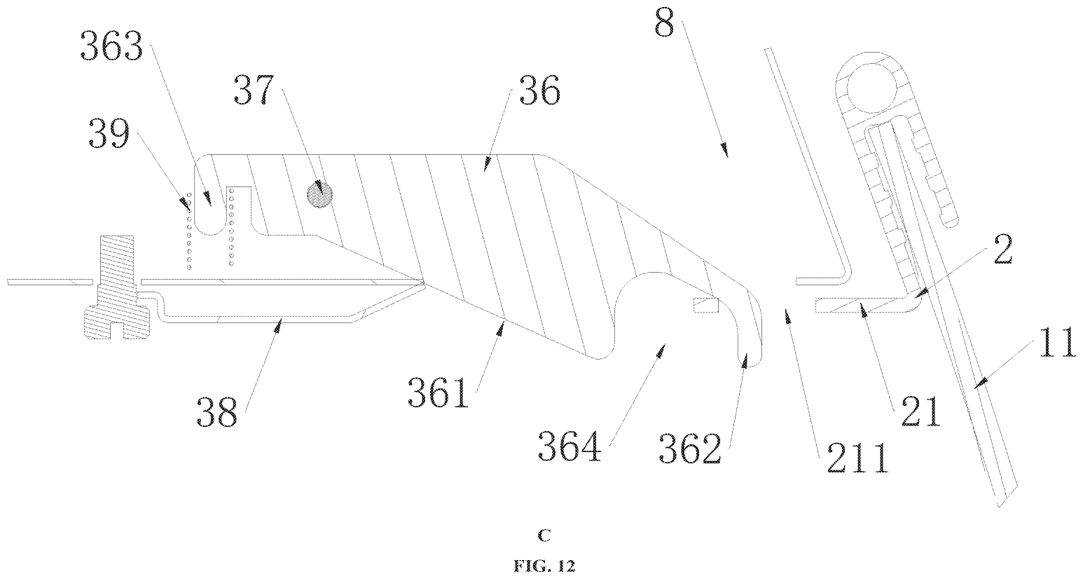

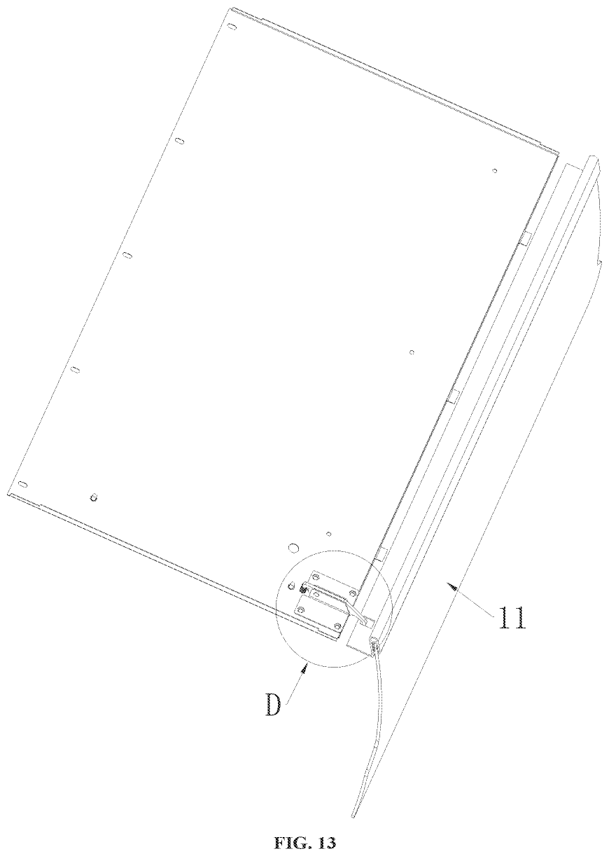

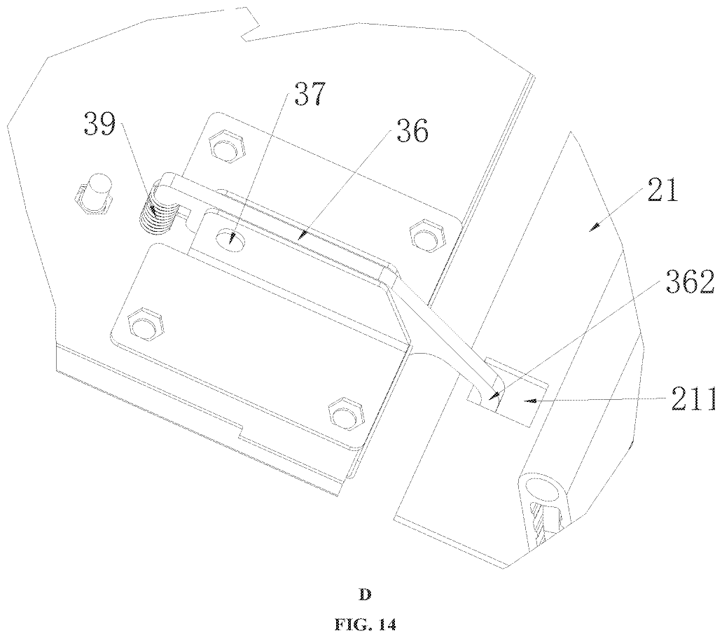

Referring to FIGS. 11-14, a controllable front door opening structure for a double-door display case includes case body 1. A front side of the case body 1 is rotatably connected to front door 11. An inner side of the front door 11 is connected to limiting member 2. The limiting member 2 rotates synchronously with the front door 11. Locking member 3 is provided in the case body 1. The locking member 3 limits rotation of the limiting member 2. Different from Embodiment 1, the limiting member 2 includes backward-extending first limiting portion 21. Lockhole 211 is formed in the first limiting portion 21. The locking member 3 includes lock piece 36. In response to an initial state, the lock piece 36 is at least partially inserted into the lockhole 211 to limit the rotation of the limiting member 2. In this case, the front door 11 is locked and cannot be opened. The lock piece 36 can rotate to separate from the lockhole 211. In this case, the limiting member 2 and the front door 11 can rotate synchronously to open.

Specifically, rack 4 is provided in the case body 1. Accommodation space 8 having an opening is formed in at least one of an interior of the rack 4, an inner top of the case body 1, an inner bottom of the case body 1, an inner left side of the case body 1, and an inner right side of the case body 1. The lock piece 36 is provided in the accommodation space 8, partially extends out of the opening and is inserted into the lockhole 211.

The locking member 3 further includes pivot shaft 37, driving portion 38, and compression spring 39. The pivot shaft 37 is located in the accommodation space 8. The lock piece 36 is sleeved on an outer side of the pivot shaft 37, and rotates around the pivot shaft 37. The driving portion 38 moves forward, moves backward or rotates to push the lock piece 36 to rotate, such that the lock piece 36 rotates to separate from the lockhole 211.

In the embodiment, for ease of description and understanding, the accommodation space 8 is located in a front bottom of the rack 4. A portion of a front end of the lock piece 36 extending out of the opening is provided with lock hook 362. The lock hook 362 is inserted into the lockhole 211. In the embodiment, the pivot shaft 37 horizontally extends left and right. From a section view, after clockwise rotation of the lock piece 36 around the pivot shaft 37, the lock hook 362 can be inserted into the lockhole 211. In response to counterclockwise rotation of the lock piece 36, the lock hook 362 can be separated from the lockhole 211.

In order to keep the lock hook 362 inserted into the lockhole 211 in the initial state, the compression spring 39 is provided between a rear end of the lock piece 36 and an inner bottom of the accommodation space 8. The compression spring 39 raises the rear end of the lock piece 36 upward, such that the front end of the lock piece 36 is flipped down to keep the lock hook 362 inserted into the lockhole 211. Specifically, locating post 363 is provided on the lock piece 36. The compression spring 39 is sleeved on an outer side of the locating post 363. The compression spring 39 includes one end abutting against the lock piece 36, and the other end abutting against an inner bottom wall of the accommodation space 8. Both the locating post 363 and the lock hook 362 are located at a lower side of the lock piece 36, and extend downward.

It is to be understood by those skilled in the art that the compression spring 39 is provided between an inner wall of the accommodation space 8 and the lock piece 36, as long as the lock piece 36 can be inserted into the lockhole 211. The compression spring 39 may also be located at an end of the lock piece 36 provided with the lock hook 362. In this case, the compression spring 39 may be located at an upper side of the lock piece 36. The compression spring 39 includes one end downward abutting against the lock piece 36, and the other end abutting against an inner top wall of the accommodation space 8. Therefore, the front end of the lock piece 36 is pressed downward, and the lock hook 362 is inserted into the lockhole 211.

In the embodiment, the driving portion 38 may be a rod-like structure, a platy structure, etc. A rear end of the driving portion 38 extends to the rear door of the case body 1, and can move forward and backward along an inner wall of the case body 1, the rack 4, and the inner wall of the accommodation space 8.

The portion of the lock piece 36 extending out of the opening is provided with guiding surface 361. The guiding surface 361 may be a guiding plane, and may also be a guiding camber. The driving portion 38 moves forward to push the guiding surface 361, such that the lock piece 36 rotates. The lock piece 36 rotates toward the accommodation space 8 to separate from the lockhole 211. Or the driving portion 38 moves backward to push the guiding surface 361, such that the lock piece 36 rotates to separate from the lockhole 211. In the embodiment, for the sake of better cooperation between the lock hook 362 and the lockhole 211, arc-shaped avoidance groove 364 is formed in the lock piece 36. A forward-backward width of the avoidance groove 364 is greater than a distance from the lockhole 211 to a rear end of the limiting member 2.

It is to be understood by those skilled in the art that the driving portion 38 may also rotate. That is, a locating hole may be formed in a middle of the driving portion 38. The driving portion is provided on the bottom of the rack through a locating pin shaft. The driving portion 38 rotates around the locating pin shaft. In rotation, the driving portion 38 pushes the guiding surface 361 of the lock piece 36, such that the lock piece 36 rotates toward the accommodation space 8, and the lock hook 362 is separated from the lockhole 211.

### Embodiment 6

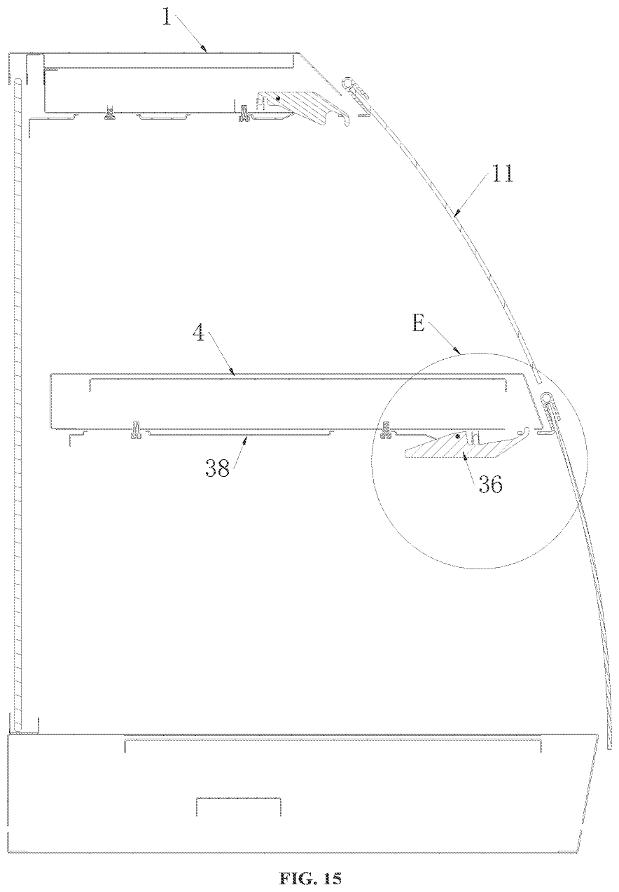

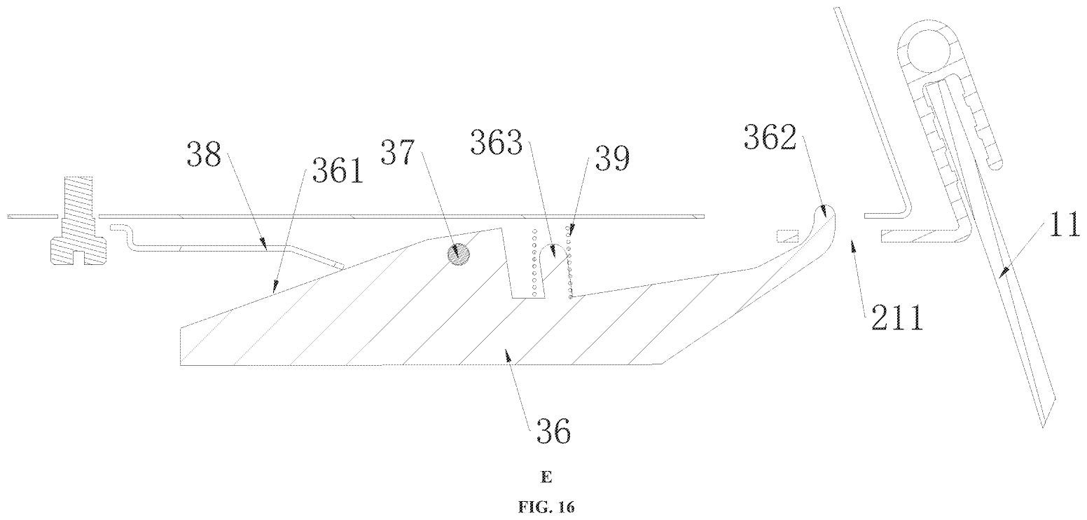

The embodiment provides a controllable front door opening structure for a double-door display case. Referring to FIGS. 15-16, different from Embodiment 5, the pivot shaft 37 in the embodiment is provided on an inner surface of the case body 1 or on an outer side of the rack 4. The inner surface of the case body 1 includes an inner top of the case body 1, an inner bottom of the case body 1, an inner left side of the case body 1, and an inner right side of the case body 1. The locating post 363 and the lock hook 362 on the lock piece 36 are located at a same side of the lock piece 36, namely at an upper side, a lower side, a left side or a right side of the lock piece 36.

In a naturally initial state, the lock piece 36 is separated from the lockhole 211. When the driving portion 38 moves to push the lock piece 36 to rotate, the lock piece 36 is inserted into the lockhole 211.

Specifically, the lock hook 362 and the guiding surface 361 are located at a same side of the lock piece 36, and located at a side of the lock piece close to the rack 4 and the inner surface of the case body 1. As shown in the figure, the lock piece 36 is located on a lower surface of the rack 4. The lock hook 362 is located at a front end of an upper surface of the lock piece 36 and extends upward. The guiding surface 361 is located at a rear end of an upper surface of the lock hook 362. The locating post 363 is located at a side of the pivot shaft 37 close to the lock hook 362, and the locating post 363 is upward. The compression spring 39 is sleeved on an outer side of the locating post 363. One end of the compression spring 39 abuts against the lock piece. The other end of the compression spring 39 abuts against the lower surface of the rack 4. The compression spring 39 applies a downward pressure to the lock piece 36, such that the lock hook 362 is downward separated from the lockhole 211 in the natural state, and the front door 11 can be opened freely. The driving portion 38 moves forward to abut against the guiding surface 361. The rear end of the lock piece 36 is flipped down, and the lock hook 362 is flipped up and inserted into the lockhole 211, such that the front door 11 cannot be opened.

Generally, components of the embodiments of the present disclosure described and shown in the accompanying drawings may be arranged and designed in various manners. Therefore, the above detailed description of the embodiments of the present disclosure in the accompanying drawings is not intended to limit the protection scope of the present disclosure, but merely indicates selected embodiments of the present disclosure.

Finally, it should be noted that the above example is merely intended to describe the technical solutions of the present disclosure, rather than to limit the present disclosure. Although the present disclosure is described in detail with reference to the above example, a person of ordinary skill in the art will understand that modifications can be made to the technical solutions described in the above example or equivalent replacements can be made to some or all technical features thereof. However, these modifications or replacements do not cause the essence of the corresponding technical solutions to depart from the scope of the technical solutions of the example of the present disclosure.

What is claimed is:

1. A controllable front door opening structure for a double-door display case, comprising a case body, wherein a front side of the case body is rotatably connected to a front door; an inner side of the front door is connected to a limiting member; the limiting member rotates synchronously with the front door; a locking member is provided in the case body; the locking member limits rotation of the limiting member; and the locking member translates or rotates to unlock the limiting member.

2. The controllable front door opening structure for the double-door display case according to claim 1, wherein the limiting member comprises a backward-extending first limiting portion; the locking member comprises a first locking portion or a second locking portion; the first locking portion or the second locking portion extends to a rotating path of the first limiting portion; and the first locking portion translates or the second locking portion rotates to separate from the rotating path of the first limiting portion.

3. The controllable front door opening structure for the double-door display case according to claim 1, wherein the limiting member comprises a second limiting portion spaced apart from the front door; the locking member comprises a second locking portion; and the locking member rotates, wherein the second locking portion extends to a front side of the second limiting portion, or the locking member rotates, wherein the second locking portion moves out of a space between the second limiting portion and the front door.

4. The controllable front door opening structure for the double-door display case according to claim 2, wherein the front door is rotatably connected to the case body through a horizontally-extending rotating shaft; a rack is provided in the case body; and the locking member is provided on a bottom or an upper portion of the rack, and/or provided on one of an inner top of the case body, an inner bottom of the case body, an inner left side of the case body, and an inner right side of the case body.

5. The controllable front door opening structure for the double-door display case according to claim 4, wherein the locking member is slidable forward and backward on the bottom of the rack, and/or the locking member is slidably provided on the inner top of the case body; the limiting member is located between the locking member and the rack, and/or the limiting member is located between the locking member and the inner top of the case body; and the locking member moves backward to separate from a rotating path of the limiting member.

6. The controllable front door opening structure for the double-door display case according to claim 4, wherein a left sidewall and a right sidewall of the case body each are provided with a guiding track; the rack drives the locking member to move forward and backward along the guiding track; the rack moves backward; and the locking member moves backward to separate from a rotating path of the limiting member.

7. The controllable front door opening structure for the double-door display case according to claim 4, wherein a locating member is provided on the bottom of the rack or the inner top of the case body; a locating hole is formed in the locating member; the locking member further comprises a connecting rod extending forward and backward; a front portion of the connecting rod is connected to the second locking portion; the connecting rod penetrates through the locating hole; and the connecting rod rotates to drive the second locking portion to rotate.

8. The controllable front door opening structure for the double-door display case according to claim 4, wherein the rotating shaft is provided on the case body; an upper end of the front door is provided with a shaft sleeve; the shaft sleeve is sleeved on an outer side of the rotating shaft, and is allowed for rotating around the rotating shaft; and the limiting member is fixedly connected to the shaft sleeve.

9. The controllable front door opening structure for the double-door display case according to claim 6, wherein a locating assembly is further provided between the rack and the locking member, or between the inner top of the case body and the locking member; the locating assembly comprises a guiding groove and a guiding member; and a first one of the guiding groove and the guiding member is provided on the rack or the inner top of the case body, and a second one of the guiding groove and the guiding member is provided on the locking member.

10. The controllable front door opening structure for the double-door display case according to claim 1, wherein a rear end of the locking member is provided with a grip.

11. The controllable front door opening structure for the double-door display case according to claim 3, wherein the front door is rotatably connected to the case body through a horizontally-extending rotating shaft; a rack is provided in the case body; and the locking member is provided on a bottom or an upper portion of the rack, and/or provided on one of an inner top of the case body, an inner bottom of the case body, an inner left side of the case body, and an inner right side of the case body.

12. The controllable front door opening structure for the double-door display case according to claim 11, wherein a locating member is provided on the bottom of the rack or the inner top of the case body; a locating hole is formed in the locating member; the locking member further comprises a connecting rod extending forward and backward; a front portion of the connecting rod is connected to the second locking portion; the connecting rod penetrates through the locating hole; and the connecting rod rotates to drive the second locking portion to rotate.

13. The controllable front door opening structure for the double-door display case according to claim 11, wherein the rotating shaft is provided on the case body; an upper end of the front door is provided with a shaft sleeve; the shaft sleeve is sleeved on an outer side of the rotating shaft, and is allowed for rotating around the rotating shaft; and the limiting member is fixedly connected to the shaft sleeve.

14. The controllable front door opening structure for the double-door display case according to claim 1, wherein the limiting member comprises a backward-extending first limiting portion; a lockhole is formed in the first limiting portion; the locking member comprises a lock piece; the lock piece is at least partially inserted into the lockhole to limit the rotation of the limiting member; and the lock piece rotates to separate from the lockhole.

15. The controllable front door opening structure for the double-door display case according to claim 14, wherein the locking member further comprises a pivot shaft and a driving portion; and the lock piece is sleeved on an outer side of the pivot shaft, and rotates around the pivot shaft; and
the driving portion moves to push the lock piece to rotate, wherein the lock piece rotates to separate from the lockhole, or the lock piece is inserted into the lockhole.

16. The controllable front door opening structure for the double-door display case according to claim 15, wherein the lock piece is provided with a guiding surface; and the driving portion moves forward to push the guiding surface, wherein the lock piece rotates to separate from the lockhole; or the driving portion moves backward to push the guiding surface, wherein the lock piece rotates to separate from the lockhole; or the driving portion rotates to push the guiding surface, wherein the lock piece rotates to separate from the lockhole; or the driving portion pushes the guiding surface, wherein the lock piece is inserted into the lockhole.

17. The controllable front door opening structure for the double-door display case according to claim 16, wherein a rack is provided in the case body; and the pivot shaft is provided on at least one of an inner surface of the case body, an outer side of the rack, and an interior of an accommodation space;
the accommodation space has an opening, and is formed in the rack or in at least one of an inner top of the case body, an inner bottom of the case body, an inner left side of the case body, and an inner right side of the case body; and
when the pivot shaft is located in the accommodation space, the lock piece partially extends out of the opening and is inserted into the lockhole.

18. The controllable front door opening structure for the double-door display case according to claim 17, wherein at least one of a position between the lock piece and the inner surface of the case body, a position between the lock piece and a surface of the rack, and a position between the lock piece and an inner wall of the accommodation space is provided with a compression spring, thereby keeping the lock piece inserted into the lockhole, or keeping the lock piece separated from the lockhole.

19. The controllable front door opening structure for the double-door display case according to claim 17, wherein one end of the lock piece is provided with a lock hook; and when the lock hook is inserted into the lockhole, and when the pivot shaft is located in the accommodation space, the lock piece extends out via the opening.

20. The controllable front door opening structure for the double-door display case according to claim 19, wherein the lock piece is provided with a locating post; a compression spring is sleeved on an outer side of the locating post; and the compression spring comprises a first end abutting against the lock piece, and a second end abutting against one of an inner wall of the accommodation space, the outer side of the rack, and the inner surface of the case body.
